(19) United States
(12) Patent Application Publication
(10) Pub. No.: US 2023/0380013 A1
(43) Pub. Date: Nov. 23, 2023

(54) SELF-ORGANIZED VEHICLE MOUNTED RELAY

(71) Applicant: IPCOM GMBH & CO. KG, Pullach (DE)

(72) Inventors: Achim LUFT, Braunschweig (DE); Andreas SCHMIDT, Braunschweig (DE); Maik BIENAS, Schoeppenstedt (DE); Martin HANS, Bad Salzdetfurth (DE)

(73) Assignee: IPCOM GMBH & CO. KG, Pullach (DE)

(21) Appl. No.: 18/247,076

(22) PCT Filed: Sep. 24, 2021
(86) PCT No.: PCT/EP2021/076336

§ 371 Date: Mar. 29, 2023

(30) Foreign Application Priority Data
Sep. 30, 2020 (EP) 20199339.1

(51) Int. Cl. H04W 88/04; H04W 88/10; H04W 84/18; H04W 4/40; H04W 76/14

(52) U.S. Cl. CPC H04W 88/04; H04W 88/10; H04W 84/18; H04W 4/40; H04W 76/14

(57) ABSTRACT

The invention provides a method of operating a first relay-capable device in a communications network, the network including a base station and a plurality of relay-capable devices, including the first relay-capable device, which are each able to act as a relay device for connection of at least one communication device to the base station, the method comprising the first relay-capable device establishing a connection with a second relay-capable device acting as a relay device for the base station; the first relay-capable device transmitting to the second relay-capable device information providing a measurement of a suitability of the first relay-capable device to act as the relay device for the base station; and after receiving from the second relay-capable device an indication that the first relay-capable device should take over as the relay device for the base station, starting operation as the relay device for the base station.

The present invention relates a method of operating a relay for allowing other devices to establish a connection with a communications network.

In 3GPP, several use cases for relays for energy efficiency and extensive coverage are currently under discussion. Increasing demands for the high data rate, high energy efficiency, and low latency in upcoming cellular communication systems can only be met by a high-dense deployment of infrastructure nodes, such as base stations, relay nodes, IAB nodes, remote radio heads. On the other side increasing electro-mobility affords the opportunity to provide this density by vehicle mounted relays. This invention is primarily concerned with vehicle mounted UE to network relays or vehicle mounted WiFi (WLAN) hotspots. Battery powered electric cars have a large battery capacity and can provide space for large antennas or antenna arrays. Other than fixed base stations or fixed relay nodes, a network topology with highly mobile vehicles mounted relays cannot be planned as with fixed base stations. The network topology has to be built in a more opportunistic manner. In one street might be a large number of vehicles with relays, in others maybe none. If all potential relays in a busy street would be active, the mobility effort and interference would be detrimental. It would be beneficial to enable the vehicle mounted relays to organize themselves without a central network entity.

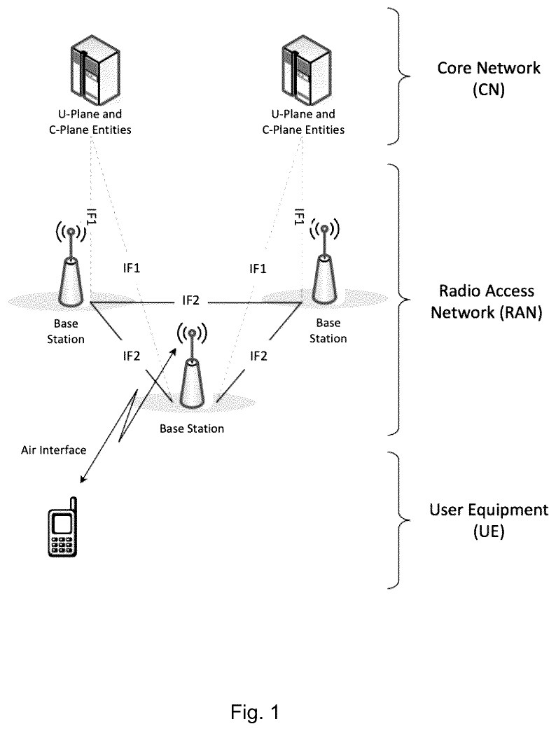

FIG. 1 shows a cellular communications system operated by a mobile network operator (MNO) according to 3GPP. Details of the functional entities shown in FIG. 1 are for instance described in 3GPP TS 36.300 (for 4G-LTE) and 3GPP TS 38.300 (for 5G-NR).

For example, in case of 5G-NR, the radio access network (RAN) consists of base stations called gNBs, providing the user plane (SDAP/PDCP/RLC/MAC/PHY) and control plane (RRC) protocol terminations towards the mobile communication devices (UEs).

The gNBs are connected by means of the NG interface (“IF1” in FIG. 1) to a core network (CN), more specifically to an access and mobility management function (AMF, taking care of control-plane or C-plane traffic) by means of a NG-C interface and to a user plane function (UPF, taking care of user-plane or U-plane traffic) by means of the NG-U interface. The NG interface supports a many-to-many relation between AMFs/UPFs and gNBs.

The gNBs are also interconnected with each other by means of an Xn interface (“IF2” in FIG. 1). The Xn interface is connecting the various base stations logically with each other. In some deployments, an Xn connection may physically be routed through the CN.

Each base station of the cellular communication system may control communication over the air interface within its geographic coverage area, namely in its radio cell or cells. When the UE is located in coverage of a radio cell and camping on it (in other words, when it is registered with the radio cell providing coverage) it may communicate with the base station controlling that radio cell. When a call is initiated by the user of the UE (mobile originated traffic) or a call is addressed to the UE (mobile terminated traffic), radio channels may be set up between the mobile communication device and the base station controlling the radio cell in which the mobile communication device is located. The air interface between a UE and its serving base station is also referred to as an access link. The entirety of all access links provided by a base station define the base station's service area.

As the mobile communication device continues to move throughout the coverage area of the cellular communication system, control of the call may be transferred between neighbouring radio cells. The transfer of calls from one radio cell to another radio cell is usually referred to as handover (or handoff). Handover is usually based on measurements (e.g., measurements of the downlink signal strength on the serving cell and/or at least one different overlapping and/or neighbouring radio cell) performed by the UE as configured by the network.

U.S. Pat. No. 8,682,243 discloses an opportunistic method in which terminals determine the most suitable network relay. A network selection device is described comprising a determining circuit configured to determine an expected suitability level of a communication connection for a communication terminal provided by means of a cellular radio communication network and by means of a relaying subscriber terminal of the cellular radio communication network and a decider configured to decide, based on the determined expected suitability level, whether the communication terminal should use a communication connection provided by means of the cellular radio communication network and by means of the relaying subscriber terminal of the cellular radio communication network.

US 2019/0098554 A1 describes the operation of a UE as a relay device in which the UE transmits configuration information to another device allowing the other device to determine whether the UE is suitable for acting as a relay for the other device to a donor eNB (DeNB). Paragraph [0077] describes how a particular UE may start acting as a relay device for UEs which are more remote from the DeNB. As described, the remote UEs can decide whether a UE closer to the DeNB can act as a relay. Once acting as a relay, the relay function can either be discontinued by the DeNB or by the UE requesting the relay.

3GPP document SP-200798 is a study of vehicle-mounted relays. A further 3GPP document S3-100896 discusses security issues of relay node architectures. A still further 3GPP document S1-203156 is a study proposal on vehicle relays. 3GPP document S1-191109 discusses multi-hop communications.

In current cellular radio systems, network elements are mainly fixed nodes in locations planned on basis of a network topology. Additionally, terminals may be enabled as single-hop or multi-hop terminal to network relay nodes, in order to enhance network coverage. Basically, direct device to device communication is used on demand for such purpose.

In the cited US '243 patent, the terminal determines the most suitable relay for opportunistic network connections. The determination of suitable existing relay nodes does not solve the problem of organizing a large amount of independent and highly mobile relay nodes. The determining function does not reflect any factors that are specific to vehicle mounted relay nodes, such as charging duration of the vehicle or programmed timer for an independent heater.

Accordingly, the present invention provides a method of operating a first relay-capable device in a communications network, the network including a base station and a plurality of relay-capable devices, including the first relay-capable device, which are each able to act as a relay device or node for connection of at least one communication device to the base station, the method comprising the first relay-capable device establishing a connection with a second relay-capable device acting as a relay device or node for the base station; the first relay-capable device transmitting to the second relay-capable device information providing a measurement of a suitability of the first relay-capable device to act as the relay device or node for the base station; and after receiving from the second relay-capable device an indication that the first relay-capable device should take over as the relay device or node for the base station, starting operation as the relay device or node for the base station.

In a further aspect, the invention provides a method of operating a second relay-capable device in a communications network, the network including a base station and a plurality of relay-capable devices, including the second relay-capable device, which are each able to act as a relay device or node for connection of at least one communication device to the base station, the method comprising the second relay-capable device acting as a relay device or node for the base station receiving from a first relay-capable device a message including information providing a measurement of a suitability of the first relay-capable device to act as the relay device or node for the base station; and after comparing the information with a measure of a suitability of the second relay-capable device to act as the relay device or node for the base station and determining that the first relay-capable device would be more suitable for acting as the relay device for the base station deactivating the second relay capable device as the relay device or node for the base station.

These two methods summarize aspects of the invention from the perspective of both a relay-capable device becoming an active relay device or node and an active relay device or node transferring such operation to a further relay-capable device. Accordingly, in a further aspect, the invention provides a method of operating a first relay-capable device and a second relay-capable device in a communications network, the network including a base station, the first and the second relay-capable device, each of which is able to act as a relay device or node for connection of at least one communication device to the base station, the method comprising at the first relay-capable device establishing a connection with the second relay-capable device acting as a relay device or node for the base station; the first relay-capable device transmitting to the second relay-capable device information providing a measurement of a suitability of the first relay-capable device to act as the relay device or node for the base station; at the second relay-capable device comparing the information with a measure of a suitability of the second relay-capable device to act as the relay device or node for the base station and upon determining that the first relay-capable device would be more suitable for acting as the relay device for the base station, providing an indication to the first relay-capable device that the first relay-capable device should take over as the relay device or node for the base station and deactivating the second relay-capable device as the relay device or node for the base station; and at the first relay-capable device, after receiving from the second relay-capable device the indication that the first relay-capable device should take over as the relay device or node for the base station, starting operation as the relay device or node for the base station.

With increasing number of potential vehicle-mounted, terminal to network relay nodes, solutions for network orchestration of highly mobile network nodes in large amounts are needed. There are three different approaches. One approach is that of centralized network orchestrated relay nodes. Here, network nodes are enabled and configured from the network. With highly mobile relay nodes this approach causes overhead data traffic. Another approach is that of opportunistic or on-demand relay nodes. Relay nodes may announce themselves or could be requested by terminals via device to device communication. The network is not orchestrated.

A third approach provided by the present invention is that of self-organized relay nodes. Highly mobile relay nodes communicate with each other to exchange parameters in order to determine which relay will stay or get enabled and which will stay or get disabled. Additionally, parameters that are specific for vehicle mounted devices are introduced that increase the precision of the network element selection. The communication between relay nodes is initially established from a potentially new relay node to an eventually existing relay node as a terminal.

In order to enable independent UE to network relays or other mobile radio access points one aspect of the invention enables potential relays to self-organize themselves by communicating with each other, determining which relay node is most suited to cover the given area and only keep the most suited relay node enabled.

It is beneficial if the initial communication between relays corresponds to the UE to relay communication. Mechanisms to determine the best suited relay are known from prior art. An evaluation, or score, is determined to identify the most suitable vehicle mounted relay as UE to network relay or WiFi hotspot. Vehicle specific parameters may be considered to determine the score, for example a time vehicle is parked, an uptime as a hotspot or UE to network relay, a start of an independent vehicle heater and a power status; e.g. whether batteries are charging.

Also, the amount of connected client UEs should be considered in this UE-to-network service score. The more UEs connected, the higher the score. This is because all connected client UEs would have been advised to connect to a new UE-to-network relay node via a handover procedure, in case the self-organizing procedure results in a change of the active relay node.

If a relay node determines that it is better suited as relay node in an area and is enabled to offer the same level of services, it can send a “take over” message to the existing relay node. If this “take over” message is acknowledged by the existing relay node and it optionally sends a “shutting down” message to all clients, the new relay node offers the same level of service from this point of time.

The present invention enables mobile relay nodes, in particular vehicle-mounted relay nodes, to self-organize in an opportunistic and decentralized manner by communication between equivalent relay nodes, determining the most suited relay node and only kept this one enabled. With one method, the operation of self-organized mobile relay nodes can be tailored to the demands at any given location and situation. Coverage holes in the fixed cell deployment can be filled. At the same time this method allows mitigation of interference caused by equivalent relay nodes at the same location.

Preferred embodiments of the invention will now be described, by way of example only, with reference to the accompanying drawings in which:

FIG. 1 shows a conventional cellular communications network architecture

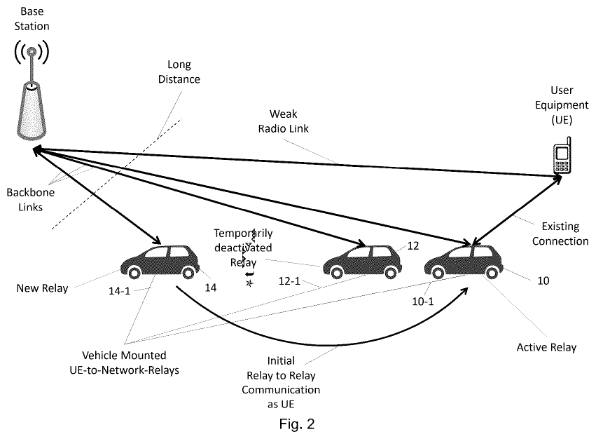

FIG. 2 shows an arrangement for implementing the invention in a mobile communications network;

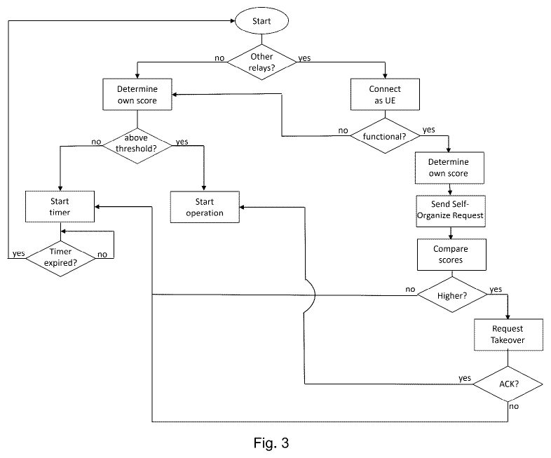

FIG. 3 shows a flow chart for an implementation the invention

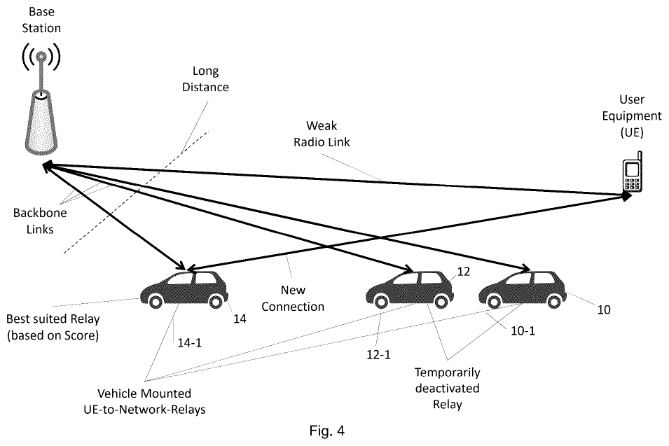

FIG. 4 shows the arrangement of FIG. 2 after a transfer to a new relay node; and

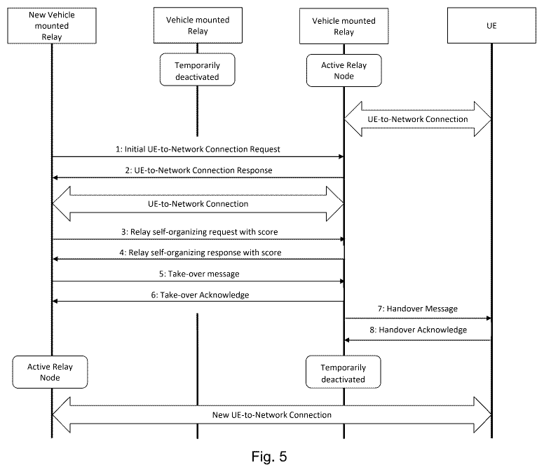

FIG. 5 is a message sequence chart for an implementation of the invention.

In FIG. 2 an architectural overview for the implementation of the invention is depicted. Vehicles 10, 12 and 14 are equipped to provide vehicle mounted UE-to-network relay nodes 10-1, 12-1 and 14-1 for the same public land mobile network (PLMN) operator. Two vehicles 10 and 12 on the right have self-organized themselves already. As a result, one relay node 12-1 has temporary deactivated itself and the other relay node 10-1 is working as a UE-to-network relay with at least one UE 16 connected. Vehicle 14 on the left is newly arrived.

FIG. 3 illustrates how such a procedure may be implemented.

The newly arrived vehicle 14 through its UE-to-network relay node 14-1 determines whether there is another running UE-to-network relay node 10-1, that can be used as relay to the same PLMN. If there are no other available relay nodes, the newly arrived UE-to-network relay node would determine whether all pre-conditions are fulfilled to operate itself as a UE-to-network relay node. This could be done by determining a score, as described below, and compare the score with a given threshold. If the score is above a threshold, the vehicle mounted relay node activates itself and starts operating. If not, the relay node starts a timer and start over after the timer has expired.

The newly arrived UE-to-network relay node 14-1 connects to the existing relay node 10-1 as a UE and verifies the general functionality and the quality of service of the existing relay node from the perspective of a UE. If the other relay node 10-1 is not working properly, the relay node starts the process over again, as if there was no other relay node.

If the other relay node 10-1 is working properly, the newly arrived UE-to-network relay node 14-1 determines whether all pre-conditions are fulfilled to operate itself as a UE-to-network relay node. This could be done by determining the own score and compare the score with a given threshold.

If all pre-conditions are met, the newly arrived UE-to-network relay node 14-1 determines a score that indicates how reliable and performant the own operation will be and what quality of service the relay node could offer. Such an opportunistic relay selection already exists in a way, that a UE is determining the best suited relay node based on such a score. In this invention a score is built to compare relay nodes with each other to enable them to self-organize among each other, in case there are several options. So, the parameters of the scores from perspective of a relay node differentiate from the parameters used to determine a score from a perspective of a UE. Vehicle specific parameters are introduced to determine this newly score from perspective of a relay node. In order to take these new parameters into account, the relay node has to be connected with a system bus of the host vehicle.

Time Vehicle is Parked

For the score the time the vehicle has been parked should be taken into account. As an example, the relay node may only start to offer a relay service 30 minutes after parking so as to avoid communication overhead between relay nodes if the vehicle is parked only for a couple of minutes.

Uptime as Hotspot or UE-to Network Relay

The time a relay node has already been operating is an important parameter of the score. If a relay node has been operating for a short period of time the score should be increased to minimize communication overhead due to frequently change of the active relay node. If a relay node has been activated for example one hour, any additional hour of operation should decrease the score to increase the possibility that another relay node with a higher score takes over. For the newly arrived vehicle, this score would be zero but not for the existing relay node 10-1.

Start of an Independent Vehicle Heater

E-Mobility is developing fast. In electric cars electric heaters are independent from any running combustion engine. Such an independent vehicle heater can be programmed to start at a given time. A programmed heater provides an indication as to a point of time when the vehicle will likely be moved. Therefore, the score should decrease with decreasing time delay towards a programmed start time of the heater.

Power Status; e.g. Whether Batteries are Charging

Fully electric and hybrid-plugin vehicles are charged while connected to a power supply. In order to charge the large vehicle batteries over a long period of time, the driver can adjust via a user interface, when the car's batteries have to be fully charged; e.g. the batteries could be charged between 11 pm and 8 am, if 8 am has been set as a point in time when the car is going to be used during next morning. Even if, no time of usages has been set by the driver, and the batteries are charged as fast as possible, the time until the batteries will be charged to 80% is an indicator as to how long this vehicle will be parked in this location with a power supply available. The longer the probable charging time, the higher the score.

The charging time is not the only parameter to compare vehicle-mounted relay nodes, but also the battery status itself. An electric car with fully charged batteries should have a higher score than a vehicle with almost completely discharged batteries, unless the discharged car is plugged in to a power supply and the batteries are currently charging.

In the situation of FIG. 2, the newly arrived UE-to-network relay node 14-1 sends a “self-organize request” message to the other active relay node 10-1. With such a message, the relay node indicates 14-1, that it is actually not a UE, but a vehicle-mounted relay node itself. This message should also contain the score in order to determine the best suited relay node. It is beneficial to secure this message. If the self-organize request message was unprotected, a denial-of-service attack could be performed by sending a self-organize request message with a maximum score. As a result of the comparison between the scores, the active relay node could deactivate itself and the denial-of-service attack would have succeeded. Security should at least ensure authenticity of an actual UE-to-network relay node to the same PLMN. This could be achieved for example by adding a digital certificate based on asymmetric cryptography. The digital signature could be issued and verified with the operator of the PLMN as certification authority. A protection against replay attacks is also strongly recommended. Otherwise, an attacker could intercept the digital certificate and generate a valid self-organize request message by including the intercepted certificate. Protection against replay attack could be achieved by transport layer security or by adding a counter or time stamp to an integrity protected message. It is also an option to use the smart card-based SIM application toolkit to generate a current digital signature with a current time stamp.

If the active relay node 10-1 implements the self-organize procedure, it verifies the authenticity of the requesting relay node, determines its own score with standardized generation of the score and acknowledges the request with an ACK message, if the score of the requesting relay node is higher than the own score, or with a NACK, if the own score is higher than the score of the requesting relay node. Both response messages could contain the own relay node score. If the active relay node 10-1 does not implement the self-organize procedure, no response message is sent.

If a response message is received in the requesting relay node 14-1, the two scores will be compared. If the other score is higher than the own score, the requesting relay node 14-1 starts a timer, and will start over the self-organize procedure after the timer has expired. The timer could be dependent of the difference in size of the two scores. If the difference is small, it is beneficial to set the timer to a longer period of time than if the difference had been large, in order to prevent a ping-pong effect in which the role of the active relay node switches frequently between two specific relay nodes with similar scores. If the other score is lower than the own score, the requesting relay nodes send a “take-over request” message. If the request is acknowledged, the newly arrived vehicle-mounted relay node 14-1 has been selected as active relay node as the result of the self-organize procedure. The new relay node 14-1 activates itself. A handover of all connected client UEs of the old relay node 10-1 towards the new relay node could be performed with direct communication between the two relay nodes. After successful handover of all client UEs, the old relay node deactivates itself, starts a timer and will start over the self-organize procedure after the timer has expired. Again, the timer could be dependent on the difference in size of the two scores. If the difference is small, it is beneficial to set the timer to a longer period of time than if the difference had been large, in order to prevent a ping-pong effect in which the role of the active relay node switches frequently between two specific relay nodes with similar scores. If no response message is received in the requesting relay node 14-1, a timer is started and the newly arrived relay node will start the self-organize procedure all over again, after the timer has expired. Whether the newly arrived vehicle-mounted relay node 14-1 will stay connected to the existing relay node 10-1 as UE may depends on whether there are connected client UEs within the host vehicle; e.g. telemetry devices.

FIG. 4 shows the arrangement of FIG. 2 after the self-organize procedure has been successfully performed. A connection between the client UE and UE-to-network relay node 14-1 has been established while UE-to-network relay nodes 10-1 and 12-1 are in a temporary deactivated state.

An exemplary event sequence chart showing exchanges of messages between the UE-to-network relay nodes and a client UE for an alternative embodiment of the invention is shown in FIG. 5.
Step 1 The newly arrived vehicle-mounted relay node, scans for advertised UE-to-network relay nodes to the same PLMN. If an active relay node is available, the newly arrived relay node initiates a connection to the network via the active relay node, as any UE would do. A connection request message is sent to the active relay node.
Step 2 The active UE-to-network relay node may answer with a connection response message to the UE, that initiated the connection, in order to acknowledge the incoming connection. The newly arrived relay node verifies the quality of service including the bandwidth, latency, and available services.
Step 3 The newly arrived relay node generates the own “service score” including the newly added specific parameters for vehicle-mounted relay nodes. It indicates with a “Relay self-organizing request” message, that it could operate also as a UE-to-network relay node in the same PLMN. This message is strongly recommended to be secured, in order to prevent a denial-of-service attack by faking such a message. If transport layer security is enabled, the message could be signed by the PLMN operator using asymmetric cryptography. The generated score is added to this message. In the active relay node, the received “Relay self-organizing request” message is verified in terms of integrity, authenticity and freshness. If the message is valid, the own “service score” is generated and compared with the received score.
Step 4 The active relay node sends back a “Relay self-organizing response” message with its own service score included.
Step 5 Assuming that the service score of the newly arrived vehicle-mounted relay node is above a stored pre-configured threshold higher than the received service score of the existing active relay node, a “takeover request” message is sent to the active relay node.
Step 6 The active relay node may compare the two scores by itself, in order to verify that a takeover is reasonable within the stored configuration. The active relay node sends back a “takeover acknowledge” message.
Step 7 The change of the active relay node to another, triggers handover messages to all connected client UEs. The handover procedure should be prepared via direct communication between new and old relay node in order to achieve seamless service continuity for connected client UEs. This preparation is not depicted in the message flow chart, because it is in accordance with the prior art.
Step 8 All connected client UEs may respond with an “handover acknowledge” message. As a result of the handover procedure, the old relay node deactivates itself and starts a timer. After the timer has expired, the now deactivated relay node starts over the self-organizing procedure with step one with scanning for active relay nodes. The newly arrived relay node has become the active relay now and my advertise itself for new client UEs; e.g. via a UE-to-network relay beacon.

Optionally, the new relay node may signal to the base station that it is operating as a relay-node. Such an indication is preferable in order to optimize the functioning of the network, for example devoting more radio resources to the new relay node.

Additionally, an arrangement is possible in which the newly arrived relay node after having determined its own service score sends a request to the active relay node requesting the active relay node to measure its service score and provide the value to the newly arrived node. The newly arrived node can then perform the comparison and determine whether it or the active relay node is in the best position to provide the relay service to the base station. If the newly arrived relay node has a higher service score, it can signal the “takeover request” to the active relay node and the relay service is transferred to the newly arrived node after a “takeover acknowledge” message has been sent followed by steps 7 and 8 as above.

If the service score of the newly arrived node is lower than that of the active relay node, again a timer could be started at the expiry of which the newly arrived relay node again determines its service score and requests an updated service score from the active relay node. Depending on a comparison at the newly arrived relay node, a transfer to the newly arrived node may then take place. The timer may have a length dependent on a difference between the two service scores.

The present invention is not limited to UE-to-network relay nodes. The principles of the invention may also be extended to WiFi (also known as WLAN) hotspots. In a second embodiment several vehicle-mounted WiFi hotspots are available in one location. The architecture is very similar to the architecture overview shown in FIG. 2. All vehicles are equipped with vehicle mounted WiFi hotspots. The main difference to the first embodiment, is that the backbone radio networks of the vehicle-mounted WiFi hotspots could be operated by different PLMN operators. The two vehicles from the right have self-organized themselves already. As the result one WiFi hotspot has temporary deactivated itself and the other is working as WiFi hotspots with at least one mobile device connected as client. The second embodiment the mobile client device could be a UE, but could also be a WiFi enabled mobile device, such as a tablet. The vehicle on the left is newly arrived in this location. The following procedure takes place. The process is similar to that depicted in FIG. 3.

The newly arrived WiFi hotspot determines whether there are other running WiFi hotspots, that can be used as internet connectivity. Distinguished from the first embodiment the access credentials could be different as 3GPP credentials. It is possible that one WiFi hotspot supports several possible access credentials or even that there are no credentials needed as the hotspot may offer free WiFi internet connectivity. Access credentials could be issued by internet providers, PLMN operators, or even communities such as “Freifunk” in Germany. If there are no other available WiFi hotspots with at least the same level of access, the newly arrived UE-to-network relay node determines whether all pre-conditions are fulfilled to operate itself as an equivalent WiFi hotspot. This could be done by determining the own score and compare the score with a given threshold. Important factor in this score is the amount of available access credentials. The more access methods are available the higher the score. If the hotspot offers free WiFi, this should lead to the highest parameter of the serve score, since this offers the best flexibility compared to closed group based WiFi hotspots. If the score is above a threshold, the vehicle mounted WiFi hotspot activates itself and starts operating. If not, the relay node starts a timer and start over after the timer has expired.

The newly arrived WiFi hotspot connects to the existing relay node as a client device and verifies the general functionality and the quality of service of the existing hotspot from the perspective of a UE. If no internet connectivity via the other hotspot is available, the new hotspot starts the process over again, as if there was no other WiFi hotspot.

If the other WiFi hotspot is working properly and internet connectivity is provided, the newly arrived WiFi hotspot determines whether all pre-conditions are fulfilled to operate itself as a WiFi hotspot. This could be done by determining the own score and compare the score with a given threshold.

If all pre-conditions are met, the newly arrived WiFi hotspot determines a score that indicates how reliable and performant the own operation will be and what quality of service the relay node could offer.

The newly arrived WiFi hotspot sends a “self-organize request” message to the other active WiFi hotspot. With such a message, the WiFi hotspot indicates, that it is actually not a client device, but a vehicle-mounted WiFi hotspot itself. This message should also contain the score in order to determine the best suited relay node. Also, in this embodiment, it is strongly recommended to secure this message. If the self-organize request message was unprotected, a denial-of-service attack could be performed by sending a self-organize request message with a maximum score. As a result of the comparison between the scores, the active WiFi hotspot would deactivate itself. The denial-of-service attack had succeeded. Security should at least ensure authenticity of an actual WiFi hotspot by the issuer of the access credentials or from a public certificate authority in case of a free WiFi hotspot.

If the active WiFi hotspot features the self-organize procedure, it verifies the authenticity of the requesting WiFi hotspot, determines the own score with standardized generation of the score and acknowledges the request with an ACK message, if the score of the requesting WiFi hotspot is higher than the own score, or with an NACK, if the own score is higher than the score of the requesting WiFi hotspot. Both response messages may contain the own relay node score. If the active WiFi hotspot not features the self-organize procedure, no response message is sent.

If a response message is received in the requesting WiFi hotspot, the two scores will be compared. If the other score is higher than the own score, the requesting WiFi hotspot starts a timer, and will start over the self-organize procedure after the timer has expired. If the other score is lower than the own score, the requesting WiFi hotspot sends a “take-over request” message. If the request is acknowledged, the newly arrived vehicle-mounted WiFi hotspot has been selected as active WiFi hotspot as the result of the self-organize procedure. The new WiFi hotspot activates itself. Since the use of WiFi hotspots has a more opportunistic character as cellular networks, a handover procedure of connected client devices may be performed as in existing WLAN mesh networks or the WiFi hotspot is simply changed without handover procedure. If no response message is received in the requesting WiFi hotspot, a timer is started and the newly arrived WiFi hotspot will start the self-organize procedure all over again, after the timer has expired. Whether the newly arrived vehicle-mounted WiFi hotspot will stay connected to the existing WiFi hotspot as client device depends on eventually connected client devices within the host vehicle; e.g. telemetry devices.

1. A method of operating a first relay-capable device in a communications network, the network including a base station and a plurality of relay-capable devices, including the first relay-capable device, which are each able to act as a relay device for connection of at least one communication device to the base station, the method comprising:
the first relay-capable device establishing a connection with a second relay-capable device acting as a relay device for the base station;
the first relay-capable device transmitting to the second relay-capable device information providing a measurement of a suitability of the first relay-capable device to act as the relay device for the base station; and
after receiving from the second relay-capable device an indication that the first relay-capable device should take over as the relay device for the base station, starting operation as the relay device for the base station.

2. A method of operating a second relay-capable device in a communications network, the network including a base station and a plurality of relay-capable devices, including the second relay-capable device, which are each able to act as a relay device for connection of at least one communication device to the base station, the method comprising:
the second relay-capable device acting as a relay device for the base station receiving from a first relay-capable device a message including information providing a measurement of a suitability of the first relay-capable device to act as the relay device for the base station; and
after comparing the information with a measure of a suitability of the second relay-capable device to act as the relay device for the base station and determining that the first relay-capable device would be more suitable for acting as the relay device for the base station deactivating the second relay capable device as the relay device for the base station.

3. The method according to claim 1 wherein the information providing a measurement of a suitability of the first relay-capable device to act as a relay device is a numerical value obtained by combining values determined for a plurality of criteria.

4. The method according to claim 3, wherein the criteria comprise at least one of:
a length of time the first relay-capable device has been stationary,
a length of time the second relay-capable device has been acting as a relay device for the base station, and
a status of a power supply to the second relay-capable device.

5. The method according to claim 4, wherein the second relay-capable device is a vehicle-mounted device and a further criterion is a programmed time for a vehicle heater operation.

6. The method according to claim 2, wherein the second relay-capable device determines its suitability to act as the relay device for the base station in the same manner as the first relay-capable device and compares a numerical value which the second relay-capable device has derived with the numerical value from the first relay-capable device.

7. The method according to claim 1, wherein the network is a public land mobile network.

8. The method according to claim 1, wherein the relay device provides an access point in a wireless local area network.

9. The method according to claim 1, wherein the transmission of information providing a measurement of a suitability of a relay-capable device to act as a relay device is security protected.

10. The method according to claim 1, wherein in the event that a response to the first relay-capable device transmitting to the second relay-capable device information providing a measurement of a suitability of the first relay-capable device to act as the relay device for the base station does not lead to the first relay-capable device starting operation as the relay device, a timer is started and upon expiry of the timer the first relay-capable device the steps of the method are repeated.

11. (canceled)

12. (canceled)

13. The method according to claim 1, wherein at least one of the first relay-capable device and the second relay-capable device is a mobile device.

14. The method according to claim 13, wherein the mobile device is a vehicle-mounted device.

15. The method according to claim 2 wherein the information providing a measurement of a suitability of the first relay-capable device to act as a relay device is a numerical value obtained by combining values determined for a plurality of criteria.

16. The method according to claim 15, wherein the criteria comprise at least one of:
a length of time the first relay-capable device has been stationary,
a length of time the second relay-capable device has been acting as a relay device for the base station, and
a status of a power supply to the second relay-capable device.

17. The method according to claim 16, wherein the second relay-capable device is a vehicle-mounted device and a further criterion is a programmed time for a vehicle heater operation.

18. The method according to claim 15, wherein the second relay-capable device determines its suitability to act as the relay device for the base station in the same manner as the first relay-capable device and compares a numerical value which the second relay-capable device has derived with the numerical value from the first relay-capable device.

19. The method according to claim 16, wherein the second relay-capable device determines its suitability to act as the relay device for the base station in the same manner as the first relay-capable device and compares a numerical value which the second relay-capable device has derived with the numerical value from the first relay-capable device.

20. The method according to claim 17, wherein the second relay-capable device determines its suitability to act as the relay device for the base station in the same manner as the first relay-capable device and compares a numerical value which the second relay-capable device has derived with the numerical value from the first relay-capable device.

21. The method according to claim 3, wherein in the event that a response to the first relay-capable device transmitting to the second relay-capable device information providing a measurement of a suitability of the first relay-capable device to act as the relay device for the base station does not lead to the first relay-capable device starting operation as the relay device, a timer is started and upon expiry of the timer the first relay-capable device the steps of the method are repeated.

22. The method according to claim 4, wherein in the event that a response to the first relay-capable device transmitting to the second relay-capable device information providing a measurement of a suitability of the first relay-capable device to act as the relay device for the base station does not lead to the first relay-capable device starting operation as the relay device, a timer is started and upon expiry of the timer the first relay-capable device the steps of the method are repeated.
